(19) United States
(12) Patent Application Publication
(10) Pub. No.: US 2006/0220982 A1
(43) Pub. Date: Oct. 5, 2006

(54) Display device, display method and recording medium

(75) Inventor: Akinobu Ueda, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 11/238,956

(22) Filed: Sep. 30, 2005

(30) Foreign Application Priority Data
Mar. 31, 2005 (JP) JP2005-105004

(51) Int. Cl. G09G 5/00

(52) U.S. Cl. 345/1.1

(57) ABSTRACT

To provide a display device capable of processing display objects displayed in a single display area distinctively on a user-by-user basis by making a display unit display the display objects displayed through operations of a plurality of users in a way that executes a process corresponding to an associated user attribute. To further provide a display system reducing traffic between a management device and a display device and a processing load on the management device by a configuration that the display device executes a process upon the display object through the operation of the user. A user's operation about a display object is accepted, the user who did the operation is identified, a user attribute specifying the identified user is associated with the display object, image data are generated by executing a process corresponding to the associated user attribute with respect to the display object, and a display unit is made to display the image data.

### BACKGROUND OF THE INVENTION

The invention relates to a technology of displaying objects for a plurality of users.

The invention relates to a so-called remote display, wherein for example, a display device is installed in a place utilized by a multiplicity of persons as in the case of a display on the street and a guide display plate in the airport, and is made to display information distributed via a network in response to a request of each individual person.

Given as products applied to this technical field are, for instance, in addition to standard PC products based on a client/server configuration, a group of non-PC products (built-in products) such as a thin client terminal, a wireless display device, a wireless TV set, which normally operate by built-in processors.

A market of the products that operate by the built-in processors as seen in the latter example of the applied products, is said to gain a tremendous growth together with spread of a ubiquitous market. It is considered from now into the future that the computer function will be incorporated into, in addition to the group of these products, more various types of devices, and especially what is considered as the built-in device that will be regarded important from now onward, may be a display device that has a large screen and can be built in a living environment such as a wall, i.e., a large-sized display device, a projection device (projector), electronic paper.

It is considered that these display devices get familiarized to the environment and are installed in every living place such as public facilities, trains, buses, individual homes without being limited to the station and airport in order to provide users with a variety of ubiquitous solutions, and get to configure an environment in which the users utilize the solutions on the network any time. The technical field is ranked as a basic technology in terms of configuring such a ubiquitous environment.

The technologies for actualizing the display device have hitherto been technologies shown in FIGS. 12 and 13.

(1) System Using RDP (Remote Desktop Protocol)

In a system in FIG. 12, a desktop screen of a server 101 is transmitted to a remote display device 101 on the basis of the RDP, and the remote display device 101 is made to display the desktop screen. In this case, the desktop screen of the server 102 is emulated and displayed by the remote display device 101, and this system is limited to a 1-to-1 application.

(2) System Using Compression/Transmission

In a system in FIG. 13, a whole image to be remote-displayed is, after being captured and compressed (encoding process) by a management device 102, transmitted to a remote display device 101, wherein the image is displayed and reproduced by expanding (decoding process) the image on the side of the remote display device 101. At this time, an MPEG method performs time-base differential compression, while a MotionJPEG method processes the image as a consecutive static image.

Further, the prior art related to the invention of this application is a technology disclosed, for example, in the following Patent document 1.

[Patent document 1] Japanese Patent Application Publication No. 2001-251594

[Non-Patent document 1] WEB site of Microsoft Corp. http://www.microsoft.com/windows2000/techinfo/howitworks/termi nal/rdpfandp.asp

### SUMMARY OF THE INVENTION

(1) Problem about Efficiency of Rendering Control Method

In the conventional example, the problem about how the ubiquitous environment is actualized is partially solved, however, a great number of problems still exist.

For instance, in the RDP-based system, a protocol level is generic, and hence there is a problem that the remote display device 101 requires a CPU and a VGA (Video Graphics Array) processing unit each having a considerable level and can not be configured at a low cost. Moreover, a specified server (e.g., Windows2000 Server (Windows is a registered trademark)) is configured flexibly to a plurality of clients but redirects the input on the side of the client as it is, and consequently the management device (management server) 102 has a high load, resulting in an unfriendly use.

Moreover, in the system using the compression and transmission, a general configuration is a 1-to-1 configuration of the management server 102 and the remote display device 101, wherein it is difficult for the single management server 102 to make the plurality of remote display devices 101 efficiently execute displaying. Then, in this system, rendering data containing a tremendous quantity of rendering information are transmitted, hence the management server 102 on the transmitting side is required to execute an encoding process for generating the rendering data, while the remote display device 101 on the receiving side is required to execute the decoding process of the rendering data, and the network between these devices is required to ensure a band for transmitting the rendering data. Therefore, both of the transmitting/receiving sides need a high-level throughput and a broadband network connection, wherein there is normally needed a cost equal to or higher than for the 1-to-1 connection of the general type of information processing devices.

(2) Problem in Terms of Cost for Multi-Development

Normally, in the case of displaying on a large-sized screen display device, it is required that the display device be at first connected to a PC (Personal computer) and then connected to the network. In the case of considering that a multiplicity of display devices are built in over the wall surface, not only the large-sized screen displays but also the PCs corresponding to the display devices are required to be disposed in the vicinity thereof, and it is therefore difficult to configure the whole system at a low cost. Further, a storage location of the PC body other than the display is also needed, and there is a large restraint in terms of space when configuring the system. Moreover, as the number of devices increases, an operation load for maintaining the respective PC gets higher, and hence a continuous operation over a long period of time is difficult.

(3) Problem about Process for User's Operation

In the conventional example, when the user conducts the operation on the side of the display device, operation information thereof is transmitted to the management server, the server generates the image data by executing a process corresponding to the operation, and the image data are transmitted to and displayed on the display device. Therefore, even when the user performs fine manipulations such as moving a cursor and changing a window size, the management server has to generate the image data corresponding to this manipulation and send the data to the display device each time, with the result that resources of the management server and network bands are greatly consumed.

Further, this type of display device is utilized by the plurality of users but could not hitherto operated simultaneously. For instance, the operation involving the input as when searching for the information, selecting and displaying history information, etc. is limited to substantially one person. To obviate this constraint, there is considered a configuration enabling the plurality of users to perform the input operations simultaneously by providing a plurality of input devices, however, this simple setting of providing the plurality of input devices results in a mixture of displays by the respective users at random in one display area, which does not seem realistic.

Such being the case, the invention provides a display device capable of processing display objects displayed in a single display area distinctively on a user-by-user basis by making a display unit display the display objects displayed through operations of a plurality of users in a way that executes a process corresponding to an associated user attribute.

Further, there is provided a display system reducing a traffic between a management device and a display device and a processing load on the management device by a configuration that the display device executes a process upon the display object through the operation of the user.

To solve the problems, the invention adopts the following configurations.

Namely, a display device and a display method of the invention perform accepting a user's operation about a display object,

identifying a user who performed the operation,

associating a user attribute specifying the identified user with the display object,

generating image data by executing a process corresponding to the user attribute associated with the display object, and

causing a display unit to display the image data.

Further, identifying information of the user may be received and compared with already-registered information, and the user may be thus authenticated.

When accepting a user's operation of displaying the display object, the display object may be displayed in a user's personal campus set in at least part of a display area of the display unit.

There is further included a step of reading the user information from a recording medium such as, an ID card, an RFID tag and a memory,

wherein when accepting the user's operation, there may be accepted the user information read from the recording medium in place of accepting the input information through the user's operation.

Further, when accepting the user's operation, there may be selectively accepted the user information.

A menu corresponding to the user information may be displayed in the personal campus.

When accepting the user's operation, in the case of accepting a user's operation of transferring the display object, the display object of the user may be transferred and thus displayed within the display area in accordance with the transfer operation.

When accepting the user's operation, in the case of accepting a user's selection of the display object, the display object associated with the user may be displayed by transferring the display object to a predetermined position in the display area.

A plurality of display objects may be rearranged in accordance with ranking information of the display objects.

A plurality of display objects may be rearranged in accordance with the user information of the display objects.

A position of the user is identified, and

a display size of the display object associated with the user may be controlled corresponding to the position of the user.

The display unit is made to display link information, and, when the link information is selected, the display object associated with the link information may be displayed.

The link information may be history information of the display object displayed in the past on the display unit.

The user's operation accepting step may involve accepting a user's operation in voice.

A group ID is assigned to a plurality of display objects that are to be grouped, and the plurality of display objects specified by the group ID may be processed batchwise.

The plurality of display objects specified by the user information may be processed batchwise.

The plurality of display objects have subordinate information representing a mutual subordinate relationship, and

the plurality of display objects may be displayed based on the subordinate information.

Slave display objects may be displayed in a predetermined positional relationship under a master display object on the basis of the subordinate information.

There may be further executed a step of obtaining a correlation between the plurality of display objects by comparing these display objects.

There may be further executed a step of obtaining a difference between the plurality of display objects by comparing these display objects.

Ranking information may be generated by comparing the plurality of display objects.

Input operations by a plurality of users operating a plurality of operation units may be accepted.

The plurality of operation units may be pointing devices.

There may be further executed a step of transmitting the image data to other display device to get the image data displayed thereon.

There may be further executed a step of transmitting the display object displayed on the display unit by copying or clipping the display object to other display device, and getting the display object displayed thereon.

In the case of displaying the display object by transferring the display object within the display area on the display unit, the display object my be transmitted to and displayed on other display device provided in parallel with the transferring direction thereof.

The user identifying step involves identifying a movement of the user, and

the personal campus associated with the user may be transferred within the display area on the display unit as the user moves, and displaying may be thus performed.

An image of the user is captured, a motion of the user is recognized based on the captured image, and the display object associated with the user may be displayed in accordance with the motion of the user.

Images of the users,

a distribution of the users is recognized based on the captured images, and

the display objects may be displayed in accordance with the distribution of the users.

Communications with a user terminal are performed, and the history information of the display objects displayed on the display unit may be transmitted to the user terminal.

Communications with a user terminal are performed, and the history information of the display object manipulated by the user may be transmitted to the user terminal on the basis of the user information.

The communications with the user terminal are performed, and, when receiving the history information from the user terminal, the display object may be displayed based on the history information.

The display object may be received from a management device on a network.

Moreover, the invention may also be a display program for making a computer execute the display method. The invention may further be a readable-by-computer recording medium recorded with this display program. The computer is made to read and execute the program on this recording medium, whereby the function thereof can be provided.

Herein, the recording medium readable by the computer connotes a recording medium capable of storing information such as data and programs electrically, magnetically, optically, mechanically or by chemical action, which can be read from the computer. Among these recording mediums, for example, a flexible disc, a magneto-optic disc, a CD-ROM, a CD-R/W, a DVD, a DAT, an 8 mm tape, a memory card, etc. are given as those demountable from the computer.

Further, a hard disc, a ROM (Read-Only Memory), etc. are given as the recording mediums fixed within the computer.

According to the invention, it is possible to provide a display device capable of processing display objects displayed in a single display area distinctively on a user-by-user basis by making a display unit display the display objects displayed through operations of a plurality of users in a way that executes a process corresponding to an associated user attribute.

Moreover, it is feasible to provide a display system reducing a traffic between a management device and a display device and a processing load on the management device by a configuration that the display device thus executes a process upon the display object through the operation of the user.

### BRIEF DESCRIPTION OF THE DRAWINGS

FIG. 1 is a schematic view of a display system according to the invention.

FIG. 2 is a diagram showing a hardware architecture of a display device.

FIG. 3 is a diagram showing a software architecture of the display device.

FIG. 4 is a diagram of an outline of configuration of a management server.

FIG. 5 is an explanatory diagram of a display method in the display system.

FIG. 6 is a front view of the display device.

FIG. 7 is a diagram showing a display example of a plurality of contents.

FIG. 8 is an explanatory diagram of a personal campus.

FIG. 9 is a diagram showing an example of linkage in the case of providing the plurality of display devices in parallel.

FIG. 10 is a diagram showing an example of performing the display corresponding to a position of the user.

FIG. 11 is a diagram showing an example of displaying the content corresponding to history information.

FIG. 12 is a diagram showing a conventional display system.

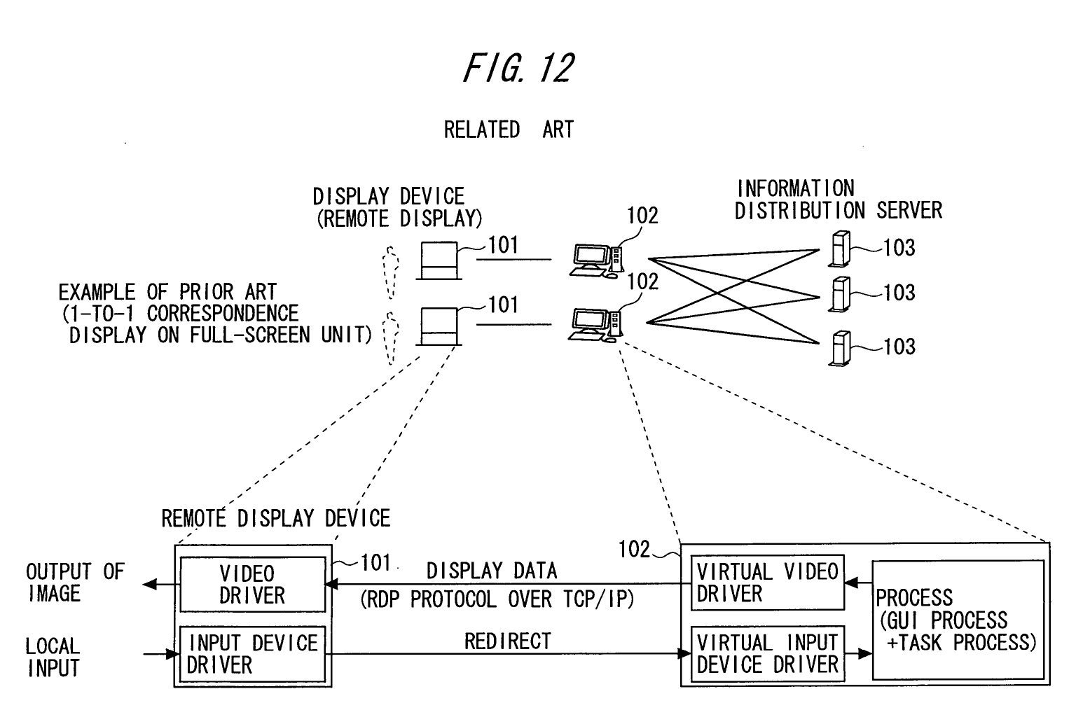

FIG. 13 is a diagram showing the conventional display system.

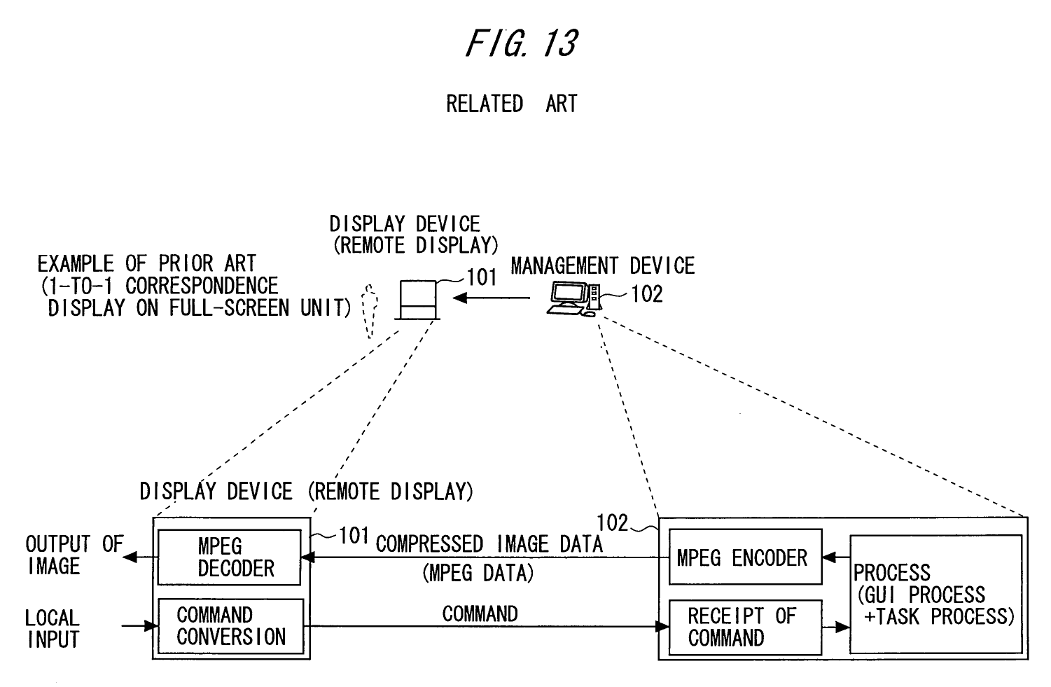

### DETAILED DESCRIPTION OF THE PREFERRED EMBODIMENT

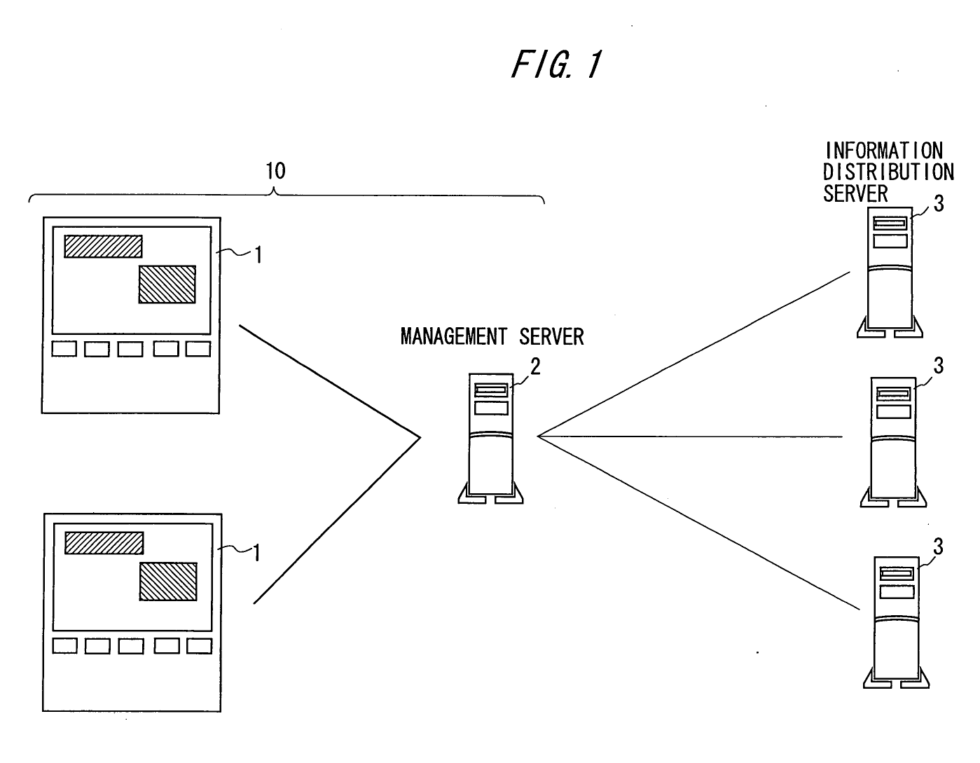

FIG. 1 is schematic view of a display system according to the invention.

A display system 10 in the example is configured by a plurality of display devices 1 and a management server 2. When display of a content (display object) is selected by a user's operation, the display device 1 requests the management server 2 for the content, the management server 2 acquires the content from an information distribution server 3 and transmits the content to the display device 1, and the display device 1 displays the content.

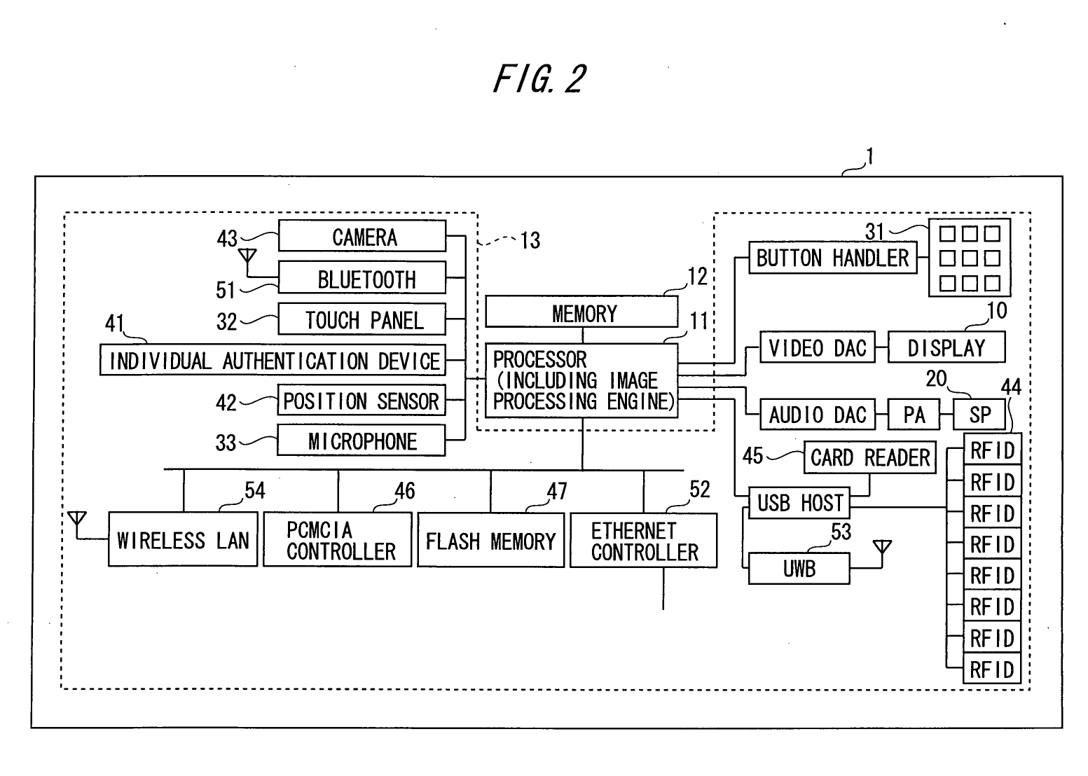

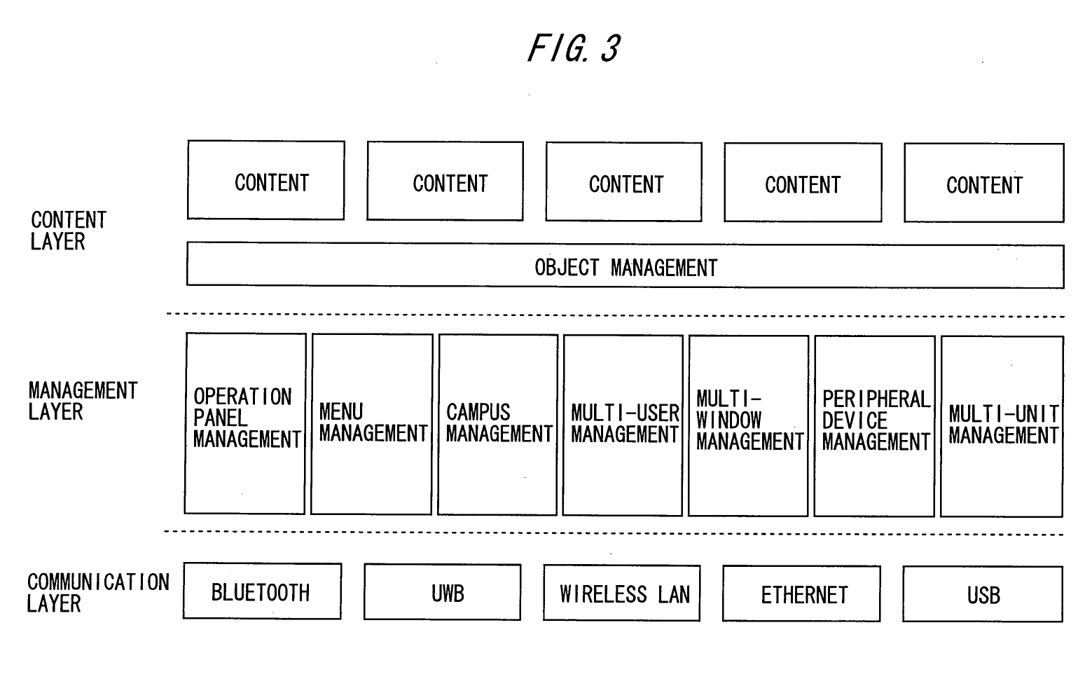

FIG. 2 is a diagram showing a hardware architecture of the display device 1, and FIG. 3 is a diagram showing a software architecture of the display device 1.

As shown in FIG. 2, the display device 1 in the embodiment includes a processor 11, a memory (storage unit) 12, an input/output unit 13, and so on.

The I/O unit 13 includes a display unit 14 for displaying the content, a loudspeaker 20 for outputting sounds when reproducing the contents (motion picture and music), an operation button 31 serving as an operation unit that accepts the user's operation, a touch panel 32, a microphone 33, an individual information reading unit 41 serving as a detection unit for detecting a position and a motion of the user, a position sensor 42, a camera (imaging device) 43, an RFID (Radio Frequency IDentification) reader/writer 44 serving as a reading unit for reading user information, a card reader 45, a PCMCIA (Personal Computer Memory Card International Association) controller 46, a FLASH memory slot 47, a Bluetooth (registered trademark) 51 serving as a communication unit for controlling communications with other computers and devices, an Ethernet (registered trademark) controller 52, a UWB (Ultra Wide Band) 53 and a wireless LAN 54.

The memory 12 is accessible at a high-speed from the processor 11, and is constructed of, in addition to a DRAM (Dynamic Access Random Memory) employed as a cache memory etc., an EPROM (Erasable Programmable Read-Only Memory) stored with a built-in OS (Operating System), a flash RAM for storing a user table, user authentication data and the user information, and so forth. Note that the memory 12 is not limited to the configuration in the example and can be arbitrarily set according to a utilization purpose.

Further, the processor 11 processes the information given from the memory 12 and the I/O unit 13, thereby functioning also as a user identifying module, an attribute recording module, an image processing module, an analyzing module (an object analyzing module), a display linkage module, a user linkage module and a content acquisition module (an object acquisition module).

The user identifying module identifies a user who executes an input operation etc. on the basis of the user information detected by the detection unit.

The attribute recording module associates the display object with a user attribute specifying the user identified by the user identifying module, and records this associated relation in a user table in the memory 12.

The image processing module generates image data by executing a process corresponding to the user attribute associated with the content.

The analyzing module compares a plurality of display objects with each other, and obtains a correlation and differences between these display objects, and thus generates ranking information.

The display linkage module performs communications for displaying in linkage with other display device such as transmitting the display object displayed on the display unit 14 to other display device in a way that copies or clips this display object, transmitting the display object to be displayed to a display device in a transfer destination in a way that transfers the object in a display area, and so on.

The user linkage module performs communications for displaying in linkage with a user terminal such as transmitting history information of the display object displayed on the display unit 14, transmitting the history information of the display object manipulated by the user to the user terminal of this user on the basis of the user information, and so forth.

The content acquisition module receives the display object from the management device 2 on the network.

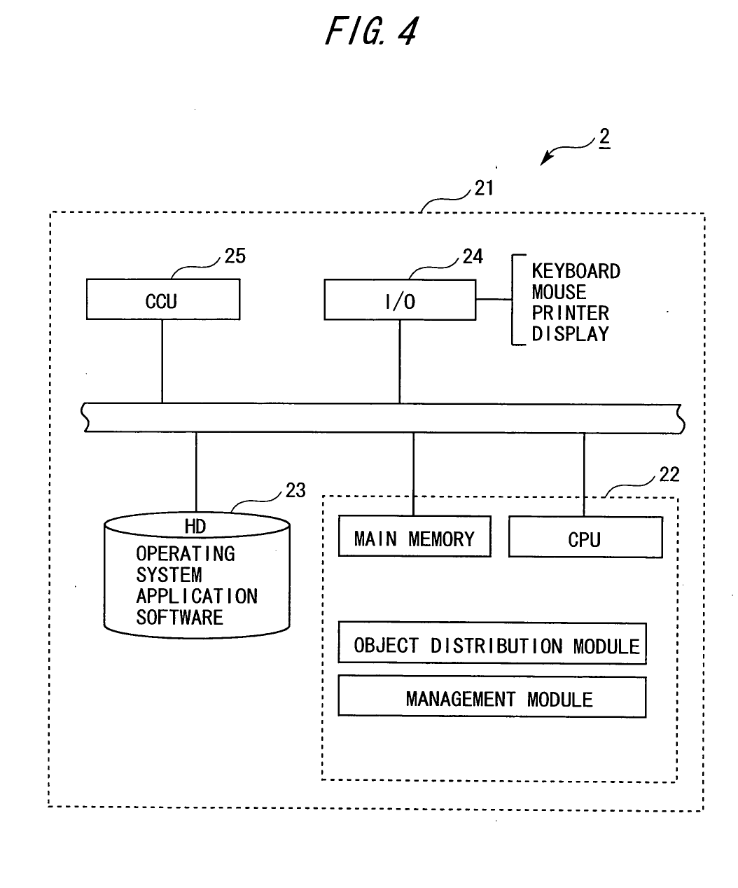

FIG. 4 is a diagram of an outline of configuration of the management server 2. As shown in FIG. 4, the management server 2 is a general type of computer having a main body 21 that includes an arithmetic processing unit 22 constructed of a CPU (Central Processing Unit), a main memory, etc., a storage unit (hard disc) 23 stored with data and software for the arithmetic process, an I/O port 24, a communication control unit (CCU) 25, and so on.

The arithmetic processing unit 22 properly reads, from the storage unit 23, and executes the OS and an application program, and effects the arithmetic process upon the information inputted from the I/O port 24 and from the communication control unit 25 and also upon the information read from the storage unit 23, thereby functioning as an object distribution module and a management module.

The object distribution module, when receiving a content request from the display device 1, acquires the content from the storage unit 23 and the information distribution server 3, and distributes the content to the display device 1.

The management module transmits user authenticating information and information about maintenance of the latest driver etc.

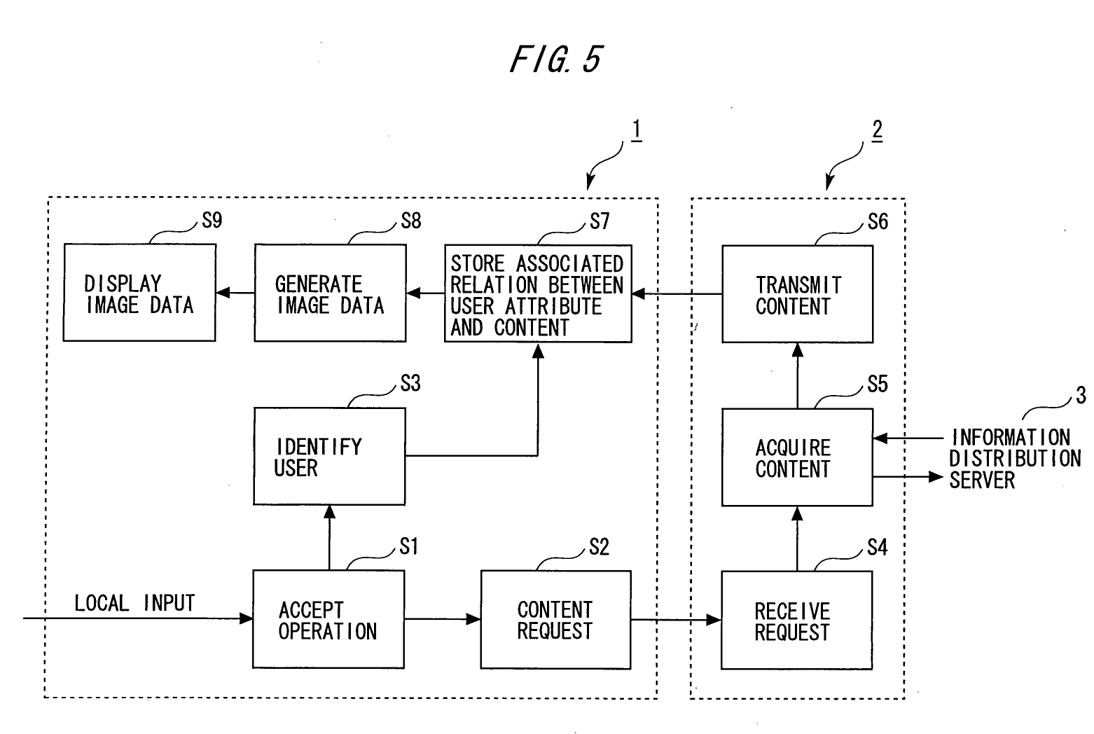

FIG. 5 is an explanatory diagram of display method in the display system 10.

When the user performs an input operation for the content, the display device 1 accepts the user's operation (step 1, which will hereinafter be abbreviated such as S1) and executes a process corresponding to this operation. Herein, if the input operation is to display the content, it is judged whether the content is stored on the cache in the memory 12, and, if not stored, the content acquisition module requests the management device 2 for the content (S2).

Further, the display device identifies the user who has done this operation by the function of the identifying module (S3).

The management server 2 receiving this request acquires the content from the information distribution server 3 by the function of the distribution module (S4, S5), and transmits the content to the display device 1 (S6).

The display device 1 registers (stores), in the user table, the associated relation between the received content and the user attribute specifying the identified user (S7).

Then, the display device 1 generates the image data by executing the process corresponding to the user attribute associated with the content through the function of the image processing module (S8), and displays the image data on the display unit 14 (S9).

A specific example about the display method will hereinafter be explained.

### SPECIFIC EXAMPLE 1

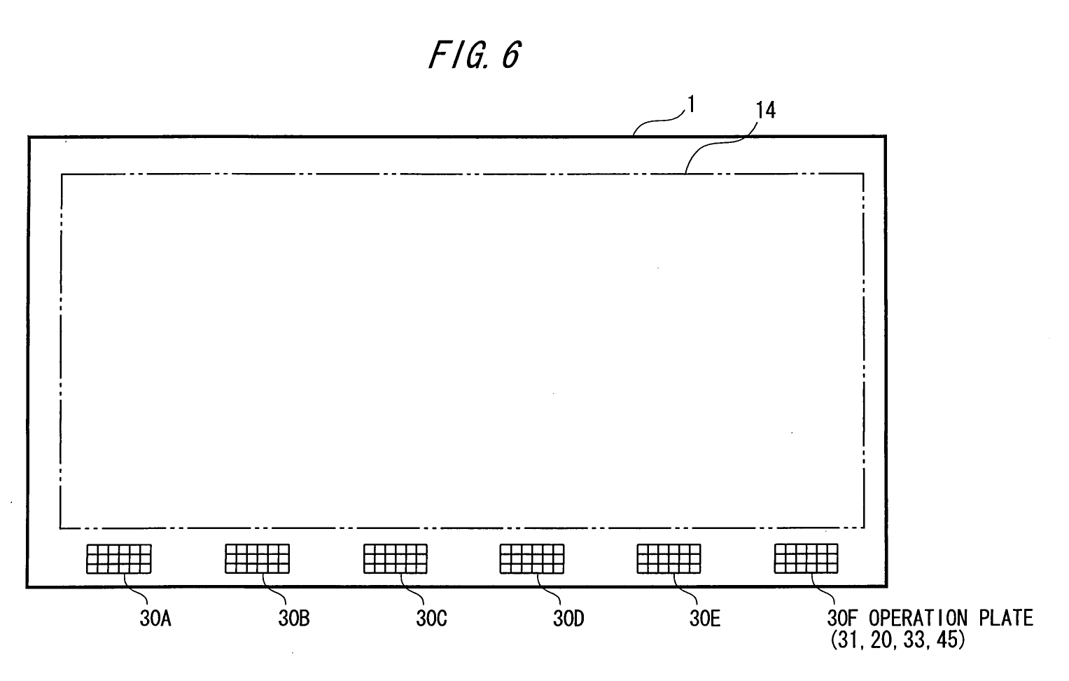

FIG. 6 is a front view of the display device 1. As shown in FIG. 6, a plurality of operation plates 30A-30F and a display unit 14 are disposed on the front surface of the display device 1, wherein a display area of the display unit 14 is depicted by a dashed double-dotted line.

The operation unit 31, the loudspeaker 20, the microphone 33 and the card reader 45 are disposed on the operation plates 30A-30F.

When the user operates the card reader of any one of the operation plates 30A-30F, for example, the operation plate 30A to read an ID card (a magnetic card, an IC card, etc.), the display device 1 reads the ID (the identification information) of this user, and authenticates the user ID by comparing with pre-registered authentication data. If the user ID is coincident with the authentication data, the display device 1 recognizes that the user logged in from the operation plate 30A, and identifies the operation from the operation plate 30A is the operation conducted by this user till log-off is done.

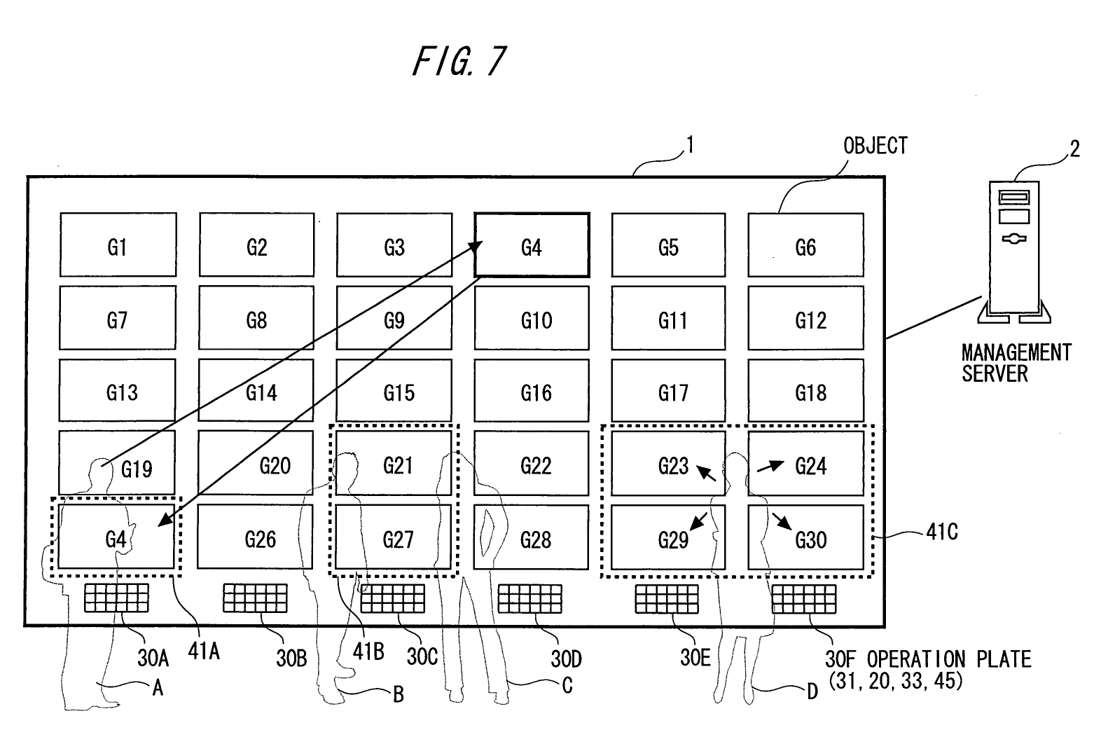

As shown in FIG. 7, in the case of displaying a plurality of contents G1-G30 on the display unit 14, when the user operates to select any one of the contents, the attribute recording module stores the selected content (which is the content G4 in the example in FIG. 7) in the user table in a way that associates the selected content with the user attribute of this user, and the image processing module generates image data of the content G4 transferred or copied to the a personal campus (an area indicated by a broken line) of the user on the basis of this user attribute and makes the display unit 14 display the image data. Herein, the personal campus is defined as an area occupied by each individual user and is set by the image processing module as in the case of selecting the desired content as described above, and so on. The personal campus may be set in an arbitrary position, however, in the example, this campus is set in close proximity to the operation plates 30A-30F operated by the user on the basis of the user attribute. Note that in the example, the attribute recording module stores the user table with information showing which position the content is displayed, which user personal campus is set and where this campus is set. A common campus corresponds to an area excluding the personal campus in the display area on the display unit 14, and the display device 1 periodically acquires a new content from the management server 2 by referring to the user table and displays the new content in the area where the personal campus is not set, i.e., in the common campus.

Through this operation, the user can gain such availability as to select a favorite content from the contents displayed in the common campus on the displayed device 1 and to examine the content in detail by transferring the content to the personal campus. For instance, advance announcements of movies are displayed as contents in the common campus, and the user who has an interest in this movie can get such individual utilization by transferring it to the personal campus that the movie is reproduced from the beginning, the sound is reproduced from the individual loudspeaker 20, and detailed information such as cast, running theaters, etc. is displayed on hand. The plurality of contents such as 61B, 61C may be displayed in the personal campus. Further, a plural number of users B, C may share the single personal campus 61B by making one operation plate 30 read a plurality of IDs.

Herein, the display device 1 conducts locally the operations such as transferring the content, reproducing the content and so on. If in the conventional system, in the case of the display image being changed by the operation such as selecting and transferring the content, the server-side generates the image data corresponding to this operation and transmits the image data to the display device each time, and consequently loads applied to the network and the server become high. By contrast, in the display device 1 in the embodiment, after receiving the content from the management server, the image processing module of the display device generates the image data corresponding to the selection and the transfer of the content, and hence consumption of network bands and resources of the server is restrained.

Further, the contents may also be advertisements of tours and concerts. The user, who sees the display of the advertisement and takes a fancy to it, transfers the content to the personal campus, wherein an application form is displayed, necessary items are inputted from on the operation plate 30, and the items-entered application form is sent to the management server 2 or the information distribution server 3, thus enabling the application for the tour or the concert to be made. Herein, as for the operation of inputting the necessary items, the user information read by the card reader 45 from the ID card may also be accepted instead of being accepted by the operation button 31.

For example, the ID card is stored with the user information such as an address, a name, a telephone number, a user's birth date, a credit number, etc., and the necessary items are added as metadata to the application form distributed from the management server 2.

With this operation, the display device 1, when receiving the application form, displays a message prompting the user to input such as [Will you input your address, name and credit number?] on the basis of the metadata thereof, and, if the input is selected, reads the address, the name and the credit number selectively from the ID card and transmits them to the management server 2. Thus, the system is configured so that the information stored beforehand on the ID card can be inputted, whereby the information input operation can be easily performed as by the keyboard even in an environment where the arbitrary characters can not be inputted. Further, it is possible to efficiently input the information such as the name, the address, etc that are frequently inputted with repetition. Moreover, there is no necessity of causing the display unit to display the input information, and the information of the individual can be inputted in safety even in such an environment that the plurality of users share the display unit with each other.

Note that the medium stored with the user information may also be, without being limited to the ID card, the RFID tag, a semiconductor memory, etc.

Moreover, when the ranking information is added to the content, the plurality of display objects can be rearranged in accordance with the ranking information.

For example, if the content is a promotion video of a CD and if the ranking information such as the number of sold CDs, the number of requests (the number of selections), etc. is added, the image processing module of the display device 1, when the user conducts the operation of indicating the rearrangement, rearranges those contents in an ascending order or descending order based on the ranking information of the contents associated with the user, and thus displays these rearranged contents.

Furthermore, in the case of rearranging the plurality of contents, the rearrangement may also be made according to the user information of the contents. For instance, the contents associated with the same user are displayed in superposition but are displayed so that these contents are not superposed on the contents associated with other users. Alternatively, the sequence of genres in which the user is interested is recorded as the user information, and the contents may be rearranged and displayed based on the genres added as content attributes.

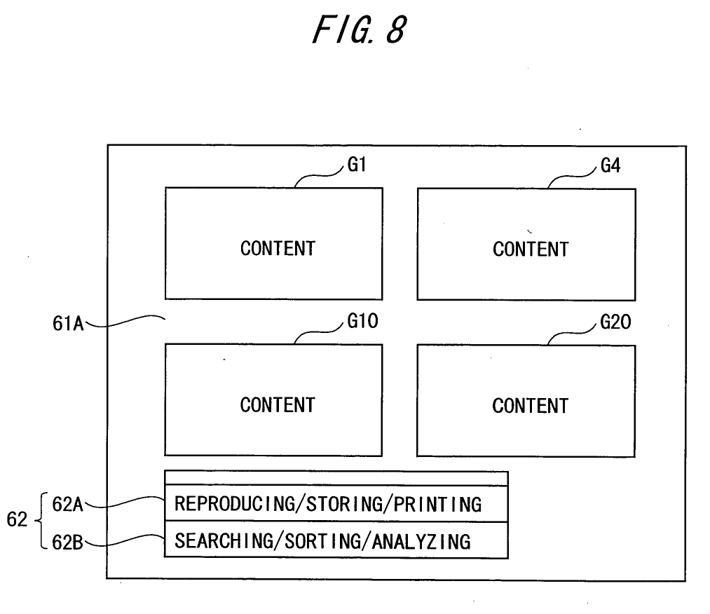

A menu 62 can be, as shown in FIG. 8, displayed in the personal campus of each user. The menu area 62 is constructed of a common menu area 62A and an individual menu area 62B, and a display content can be customized in the individual menu area 62B. The customized-by-the-user display content in the individual menu area 62B is stored as the user information on the memory 12 and is, when the user logs in, read out and displayed in the individual menu area 62B.

With this contrivance, when performing the operation for the object in the personal campus, an unified operation environment can be provided. Further, the operation across between the objects can be actualized.

Moreover, the operation unit for conducting the operation such as selecting and transferring the content can involve using, in addition to the operation button 31, a touch panel 32 and a pointing device. A desirable device as the pointing device is a wireless device connected to the wireless LAN 51 and the Bluetooth 54. Further, the content may also be manipulated by inputting a voice instruction of the user from the microphone 33 and thus recognizing the content of the instruction through the voice recognition.

Moreover, in the example, the plurality of contents can be grouped. When the user selects the plurality of contents and gives an instruction of grouping the contents, the display device 1 assigns a common group ID to the plurality of contents. Then, in the case of performing the operation such as transferring and deleting any one of the grouped contents, the image processing module batchwise transfers and deletes the contents assigned the same group ID, and then effects displaying.

Moreover, if subordinate information representing a subordinate relationship is added to the contents, the image processing module displays the contents in a positional relationship based on this subordinate relationship.

For instance, in related contents in a relationship as between a image and specification of a personal computer, a picture and data (specification) of a car, etc., a master content and a slave content are determined based on the subordinate information, and the display is conducted in a predetermined positional relationship as by displaying the slave content under the master content. Then, the content is, in the case of its transfer, transferred while keeping this positional relationship.

Further, in the example, the plurality of contents displayed in the personal campus can be compared and analyzed by the function of the analyzing module.

The images of the plurality of cars are displayed as the contents, and, when designating the image of the car serving as the standard, the images of the cars taking similar shapes are extracted. Alternatively, in the case of displaying plural types of specifications of the personal computers as the contents, different elements among the contents are obtained. Furthermore, as a result of the comparison, the ranking information may also be created in the sequence of the price from the cheapest or in the sequence of the performance from the highest.

### SPECIFIC EXAMPLE 2

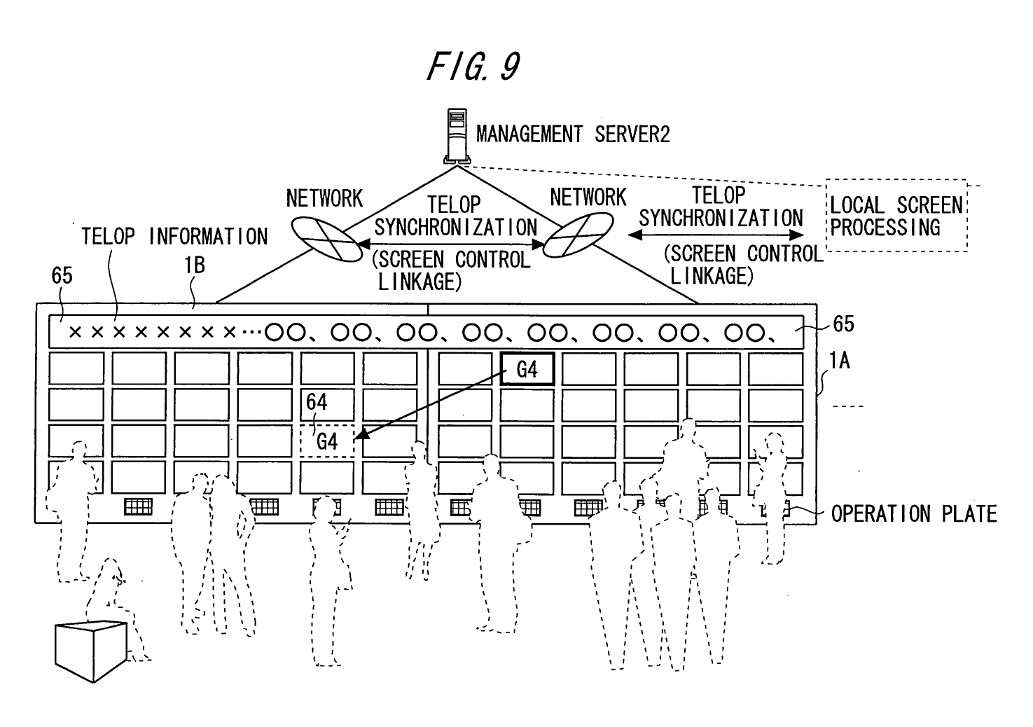

FIG. 9 shows an example of linkage in the case of providing the plurality of display devices in parallel. The example is such that when performing the operation of transferring or copying the content (which is G4 in FIG. 9) between the plurality of display devices 1A, 1B, the operation across between the plurality of devices can be done by transmitting the content G4 between the display devices. For instance, in the case of effecting the operation of transferring the content G4 from the operation plate 30 of the display device 1A to a position 63 on the display device 1B, the linkage module of the display device 1A clips and transmits the content G4 to the display device 1B together with the information about a transfer destination (a position 64). Then, in the display device 1B receiving he content G4, the image processing module displays the content G4 in the position 64.

Moreover, the display device 1A in the example, when receiving telop information as a content, displays the telop information in a way that moves the telop information from right to left in a telop display area 65, and transmits the telop information to the display device 1B provided in parallel with the moving direction. Then, the display device 1B receiving the telop information displays the telop information in the similar way that moves the telop information from right to left in the telop display area 65, whereby the telop display can be done across between the plurality of devices.

At this time, for example, the display devices 1A, 1B take clock synchronization based on NTP (Network Time Protocol) etc., and the display device 1A notifies the display device 1B of display end time (i.e., the time when the telop information reaches the left end of the area 65) together with the telop information, thereby enabling the display device 1B to consecutively display the telop information.

Thus, the display device in the example can transmit the content to other display device without via the server and can display in linkage without increasing the load on the server.

### SPECIFIC EXAMPLE 3

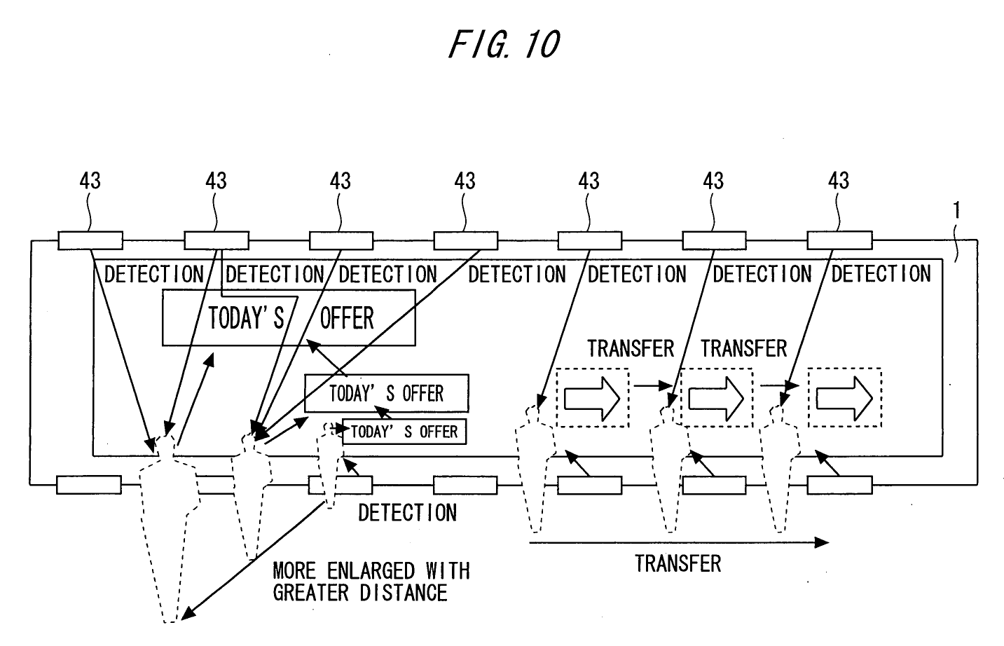

FIG. 10 is a diagram showing an example of conducting the display corresponding to a position of the user. The display device 1 in the example includes a plurality of cameras (detection units) 43, wherein a user identifying module identifies a position of the user by executing image processing upon an image captured by the camera 43, and an image processing module displays the content matching with the user's position.

For instance, when the user is moving, the content is transferred synchronizing with the movement of the user and thus displayed. Note that when the user has already been authenticated, the content and the personal campus each associated with the user are transferred batchwise.

Further, if the user exists at a far distance, a display size of the content is enlarged, i.e., the number of pixels of the display is increased in the case of the image, and a font size is increased in the case of a text. Conversely if the user exists very close, the display size of the content can be adjusted corresponding to the distance of the user so as to reduce the display size of the content.

Moreover, the position of the user may be detected by use of, without being limited to the camera 43, a position sensor based on an infrared-ray system and an ultrasonic system and by use of the active RFID and UWB based on the wireless system.

### SPECIFIC EXAMPLE 4

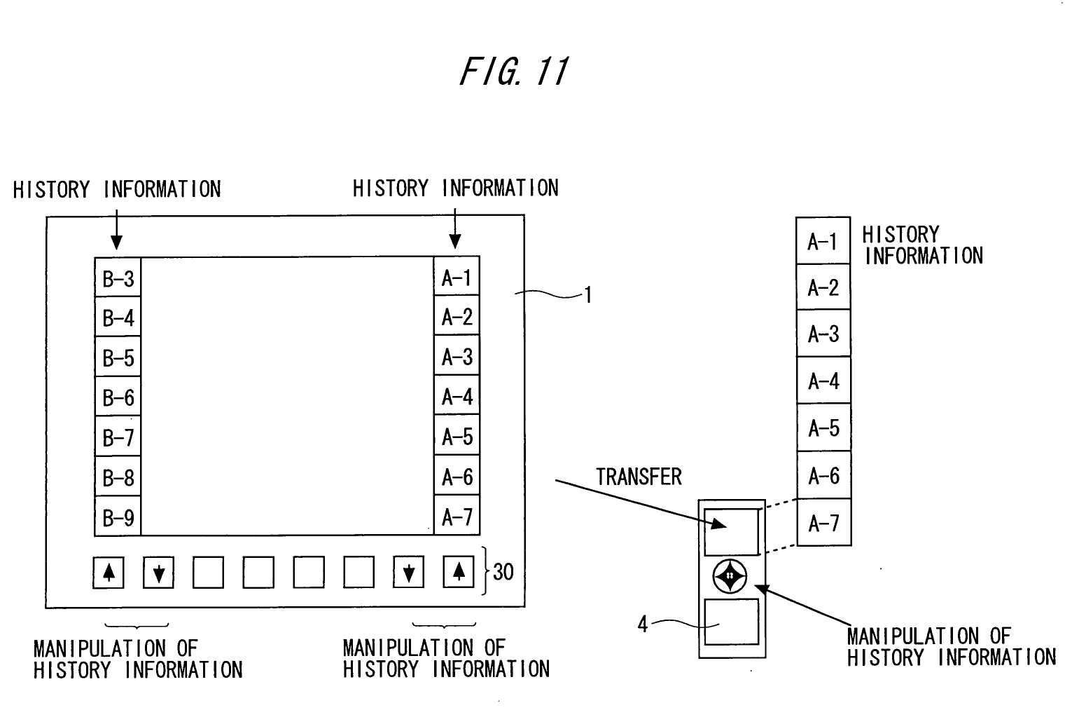

FIG. 11 shows an example of displaying the content associated with history information. The display device 1 in the example displays pieces of history information A-1 through A-9 and B-1 through B-9 at both side ends in the display area, and, when the history information is selected, displays the content associated with the selected information in the display area. Note that the pieces of history information A-8 through A-9 and B-1 through B-2, which are not displayed on the display unit, can be displayed by manipulating arrowhead keys (cursor keys) on the operation plate 30.

The history information contains pieces of display information such as titles, reduced images (thumbnails) and captions of the contents, and pieces of information (link destination information) about storage locations of the contents.

When the user selects the history information by the cursor key on the operation plate 30, the display device 1 acquires, based on the link destination information contained in the selected history information, the content from the memory 12 or the management server 2, and displays the content in the display area.

The history information is such that pieces of information of the contents displayed in the common campus are added in sequence.

Further, the user linkage module of the display device 1 can transmit this history information to a user terminal such as a cellular phone and a PDA (Personal Digital Assistant) of the user. The user can select the history information on the user terminal 4 receiving the history information and can redisplay the content associated with the history information on the display device 1 by sending the selected history information to the user linkage module of the display device 1 from the user terminal 4.

The history information may also be, without being limited to the history (information) in the common campus, history information of the contents displayed in the personal campus, i.e., the history information of the contents associated with the user.

<Others>

The invention is not limited to only the illustrated examples given above and can be, as a matter of course, changed in a variety of forms in the range that does not deviate from the gist of the invention.

For example, even the configurations given in the following Notes can acquire the same effects as those in the embodiments discussed above. Further, the components thereof can be combined to the greatest possible degree.

(Note 1)

A display device comprising:
an operation unit accepting a user's operation about a display object;

a user identifying module identifying a user who performed the operation;

an attribute recording module associating a user attribute specifying the user identified by the user identifying module with the display object;

an image processing module generating image data by executing a process corresponding to the user attribute associated with the display object; and

a display unit displaying the image data.

(Note 2)

A display device according to Note 1, wherein the user identifying module receives identifying information of the user, compares the identifying information with already-registered information, and thus authenticates the user.

(Note 3)

A display device according to Note 1 or 2, wherein when the operation unit accepts a user s operation of displaying the display object, the image processing module displays the display object in a user's personal campus set in at least part of a display area of the display unit.

(Note 4)

A display device according to any one of Notes 1 through 3, further comprising a reading unit reading the user information from a recording medium such as, an ID card, an RFID tag and a memory, wherein the operation unit accepts the user information read by the reading unit in place of accepting the input information through the user's operation.

(Note 5)

A display device according to Note 4, wherein the operation unit selectively accepts the user information.

(Note 6)

A display device according to Note 3, wherein the image processing module displays a menu corresponding to the user information in the personal campus.

(Note 7)

A display device according to Note 3, wherein when the operation unit accepts a user's operation of transferring the display object, the image processing module transfers the display object of the user within the display area in accordance with the transfer operation.

(Note 8)

A display device according to Note 3, wherein when the operation unit accepts a user's selection of the display object, the image processing module displays the display object associated with the user by transferring the display object to a predetermined position in the display area.

(Note 9)

A display device according to any one of Notes 1 through 8, wherein the image processing module rearranges a plurality of display objects in accordance with ranking information of the display objects.

(Note 10)

A display device according to any one of Notes 1 through 8, wherein the image processing module rearranges a plurality of display objects in accordance with the user information of the display objects.

(Note 11)

A display device according to any one of Notes 1 through 10, wherein the user identifying module identifies a position of the user, and

the image processing module controls a display size of the display object associated with the user, corresponding to the position of the user.

(Note 12)

A display device according to any one of Notes 1 through 11, wherein the image processing module makes the display unit display link information, and, when the link information is selected, makes the display unit display the display object associated with the link information.

(Note 13)

A display device according to Note 12, wherein the link information is history information of the display object displayed in the past on the display unit.

(Note 14)

A display device according to any one of Notes 1 through 13, wherein the operation unit accepts a user's operation in voice.

(Note 15)

A display device according to any one of Notes 1 through 14, wherein the attribute recording module assigns a group ID to a plurality of display objects that are to be grouped, and

the image processing module processes batchwise the plurality of display objects specified by the group ID.

(Note 16)

A display device according to any one of Notes 1 through 14, wherein the image processing module processes batchwise the plurality of display objects specified by the user information.

(Note 17)

A display device according to any one of Notes 1 through 16, wherein the plurality of display objects have subordinate information representing a mutual subordinate relationship, and

the image processing module gets the plurality of display objects displayed based on the subordinate information.

(Note 18)

A display device according to Note 17, wherein the image processing module gets slave display objects displayed in a predetermined positional relationship under a master display object on the basis of the subordinate information.

(Note 19)

A display device according to any one of Notes 1 through 18, further comprising an object analyzing module obtaining a correlation between the plurality of display objects by comparing these display objects.

(Note 20)

A display device according to any one of Notes 1 through 19, further comprising an object analyzing module obtaining a difference between the plurality of display objects by comparing these display objects.

(Note 21)

A display device according to any one of Notes 1 through 20, further comprising an object analyzing module generating ranking information by comparing the plurality of display objects.

(Note 22)

A display device according to any one of Notes 1 through 20, further comprising a plurality of operation units by which a plurality of users can simultaneously perform input operations.

(Note 23)

A display device according to Note 22, wherein the plurality of operation units are pointing devices.

(Note 24)

A display device according to any one of Notes 1 through 23, further comprising a display linkage module transmitting the image data to other display device to get the image data displayed thereon.

(Note 25)

A display device according to any one of Notes 1 through 24, further comprising a display linkage module transmitting the display object displayed on the display unit by copying or clipping the display object to other display device, and getting the display object displayed thereon.

(Note 26)

A display device according to any one of Notes 1 through 25, further comprising a display linkage module transmitting, in the case of displaying the display object by transferring the display object within the display area on the display unit, the display object to other display device provided in parallel with the transferring direction thereof, and getting the display object displayed thereon.

(Note 27)

A display device according to any one of Notes 1 through 26, wherein the user identifying module identifies a movement of the user, and

the image processing module transfers the personal campus associated with the user within the display area on the display unit as the user moves, and thus performs displaying.

(Note 28)

A display device according to any one of Notes 1 through 26, further comprising an imaging unit imaging the user, wherein the user identifying module recognizes a motion of the user on the basis of the image captured by the imaging unit, and the image processing module displays the display object associated with the user in accordance with the motion of the user.

(Note 29)

A display device according to any one of Notes 1 through 28, further comprising an imaging unit imaging the users, wherein the user identifying module recognizes a distribution of the users on the basis of the images captured by the imaging unit, and

the image processing module displays the display objects in accordance with the distribution of the users.

(Note 30)

A display device according to any one of Notes 1 through 29, further comprising a user linkage module performing communications with a user terminal, wherein
the user linkage module transmits the history information of the display objects displayed on the display unit to the user terminal.

(Note 31)

A display device according to any one of Notes 1 through 29, further comprising a user linkage module performing communications with a user terminal,

wherein the user linkage module transmits the history information of the display object manipulated by the user to the user terminal on the basis of the user information.

(Note 32)

A display device according to Note 31, wherein the user linkage module receives the history information from the user terminal, and the image processing module gets the display object displayed based on the history information.

(Note 33)

A display device according to any one of Notes 1 through 32, further comprising an object acquisition module receiving the display object from a management device on a network.

(Note 34)

A display method by which a display device executes:
a step of accepting a user's operation about a display object;

a step of identifying a user who performed the operation;

a step of associating a user attribute specifying the identified user with the display object;

a step of generating image data by executing a process corresponding to the user attribute associated with the display object; and

a step of causing a display unit to display the image data.

(Note 35)

A display method according to Note 34, wherein identifying information of the user is received and compared with already-registered information, and the user is thus authenticated.

(Note 36)

A display method according to Note 34 or 35, wherein when accepting a user's operation of displaying the display object, the display object is displayed in a user's personal campus set in at least part of a display area of the display unit.

(Note 37)

A display method according to any one of Notes 34 through 36, further comprising a step of reading the user information from a recording medium such as, an ID card, an RFID tag and a memory, wherein the user's operation accepting step involves accepting the user information read from the recording medium in place of accepting the input information through the user's operation.

(Note 38)

A display method according to Note 37, wherein the user's operation accepting step involves selectively accepting the user information.

(Note 39)

A display method according to Note 36, wherein a menu corresponding to the user information is displayed in the personal campus.

(Note 40)

A display method according to Note 36, wherein the user's operation accepting step involves, when accepting a user's operation of transferring the display object, transferring the display object of the user within the display area in accordance with the transfer operation.

(Note 41)

A display method according to Note 36, wherein the user's operation accepting step involves, when accepting a user's selection of the display object, displaying the display object associated with the user by transferring the display object to a predetermined position in the display area.

(Note 42)

A display method according to any one of Notes 34 through 41, wherein a plurality of display objects are rearranged in accordance with ranking information of the display objects.

(Note 43)

A display method according to any one of Notes 34 through 41, wherein a plurality of display objects are rearranged in accordance with the user information of the display objects.

(Note 44)

A display method according to any one of Notes 34 through 43, wherein a position of the user is identified, and a display size of the display object associated with the user is controlled corresponding to the position of the user.

(Note 45)

A display method according to any one of Notes 34 through 44, wherein the display unit is made to display link information, and, when the link information is selected, the display object associated with the link information is displayed.

(Note 46)

A display method according to Note 45, wherein the link information is history information of the display object displayed in the past on the display unit.

(Note 47)

A display method according to any one of Notes 34 through 46, wherein the user's operation accepting step involves accepting a user's operation in voice.

(Note 48)

A display method according to any one of Notes 34 through 47, wherein a group ID is assigned to a plurality of display objects that are to be grouped, and

the plurality of display objects specified by the group ID are processed batchwise.

(Note 49)

A display method according to any one of Notes 34 through 47, wherein the plurality of display objects specified by the user information are processed batchwise.

(Note 50)

A display method according to any one of Notes 34 through 49, wherein the plurality of display objects have subordinate information representing a mutual subordinate relationship, and the plurality of display objects are displayed based on the subordinate information.

(Note 51)

A display method according to Note 50, wherein slave display objects are displayed in a predetermined positional relationship under a master display object on the basis of the subordinate information.

(Note 52)

A display method according to any one of Notes 34 through 51, wherein there is further executed a step of obtaining a correlation between the plurality of display objects by comparing these display objects.

(Note 53)

A display method according to any one of Notes 34 through 52, wherein there is further executed a step of obtaining a difference between the plurality of display objects by comparing these display objects.

(Note 54)

A display method according to any one of Notes 34 through 53, wherein there is further executed a step of generating ranking information by comparing the plurality of display objects.

(Note 55)

A display method according to any one of Notes 34 through 54, wherein input operations by a plurality of users operating a plurality of operation units are accepted.

(Note 56)

A display method according to Note 55, wherein the plurality of operation units are pointing devices.

(Note 57)

A display method according to any one of Notes 34 through 56, wherein there is further executed a step of transmitting the image data to other display device to get the image data displayed thereon.

(Note 58)

A display method according to any one of Notes 34 through 57, wherein there is further executed a step of transmitting the display object displayed on the display unit by copying or clipping the display object to other display device, and getting the display object displayed thereon.

(Note 59)

A display method according to any one of Notes 34 through 58, wherein there is further executed a step of transmitting, in the case of displaying the display object by transferring the display object within the display area on the display unit, the display object to other display device provided in parallel with the transferring direction thereof, and getting the display object displayed thereon.

(Note 60)

A display method according to any one of Notes 34 through 59, wherein the user identifying step involves identifying a movement of the user, and

the personal campus associated with the user is transferred within the display area on the display unit as the user moves, and displaying is thus performed.

(Note 61)

A display method according to any one of Notes 34 through 59, further comprising a step of imaging the user, wherein a motion of the user is recognized based on the captured image, and

the display object associated with the user is displayed in accordance with the motion of the user.

(Note 62)

A display method according to any one of Notes 34 through 61, further comprising a step of imaging the users, wherein a distribution of the users is recognized based on the captured images, and

the display objects are displayed in accordance with the distribution of the users.

(Note 63)

A display method according to any one of Notes 34 through 62, further comprising a step of performing communications with a user terminal,

wherein the communication performing step involves transmitting the history information of the display objects displayed on the display unit to the user terminal.

(Note 64)

A display method according to any one of Notes 34 through 62, further comprising a step of performing communications with a user terminal,

wherein the step of performing the communications with the user terminal involves transmitting the history information of the display object manipulated by the user to the user terminal on the basis of the user information.

(Note 65)

A display method according to Note 64, wherein the step of performing the communications with the user terminal involves, when receiving the history information from the user terminal, getting the display object displayed based on the history information.

(Note 66)

A display method according to any one of Notes 34 through 65, wherein there is further executed a step of receiving the display object from a management device on a network.

(Note 67)

A display program for making a computer execute:

a step of accepting a user's operation about a display object;

a step of identifying a user who performed the operation;

a step of associating a user attribute specifying the identified user with the display object;

a step of generating image data by executing a process corresponding to the user attribute associated with the display object; and

a step of causing a display unit to display the image data.

(Note 68)

A display program according to Note 67, wherein identifying information of the user is received and compared with already-registered information, and the user is thus authenticated.

(Note 69)

A display program according to Note 67 or 68, wherein when accepting a user's operation of displaying the display object, the display object is displayed in a user s personal campus set in at least part of a display area of the display unit.

(Note 70)

A display program according to any one of Notes 67 through 69, further comprising a step of reading the user information from a recording medium such as, an ID card, an RFID tag and a memory, wherein the user's operation accepting step involves accepting the user information read from the recording medium in place of accepting the input information through the user's operation.

(Note 71)

A display program according to Note 70, wherein the user's operation accepting step involves selectively accepting the user information.

(Note 72)

A display program according to Note 69, wherein a menu corresponding to the user information is displayed in the personal campus.

(Note 73)

A display program according to Note 69, wherein the user's operation accepting step involves, when accepting a user's operation of transferring the display object, transferring the display object of the user within the display area in accordance with the transfer operation.

(Note 74)

A display program according to Note 69, wherein the user's operation accepting step involves, when accepting a user's selection of the display object, displaying the display object associated with the user by transferring the display object to a predetermined position in the display area.

(Note 75)

A display program according to any one of Notes 67 through 74, wherein a plurality of display objects are rearranged in accordance with ranking information of the display objects.

(Note 76)

A display program according to any one of Notes 67 through 74, wherein a plurality of display objects are rearranged in accordance with the user information of the display objects.

(Note 77)

A display program according to any one of Notes 67 through 76, wherein a position of the user is identified, and

a display size of the display object associated with the user is controlled corresponding to the position of the user.

(Note 78)

A display program according to any one of Notes 67 through 77, wherein the display unit is made to display link information, and, when the link information is selected, the display object associated with the link information is displayed.

(Note 79)

A display program according to Note 78, wherein the link information is history information of the display object displayed in the past on the display unit.

(Note 80)

A display program according to any one of Notes 67 through 78, wherein the user's operation accepting step accepting a user's operation in voice.

(Note 81)

A display program according to any one of Notes 67 through 80, wherein a group ID is assigned to a plurality of display objects that are to be grouped, and

the plurality of display objects specified by the group ID are processed batchwise.

(Note 82)

A display program according to any one of Notes 67 through 80, wherein the plurality of display objects specified by the user information are processed batchwise.

(Note 83)

A display program according to any one of Notes 67 through 82, wherein the plurality of display objects have subordinate information representing a mutual subordinate relationship, and

the plurality of display objects are displayed based on the subordinate information.

(Note 84)

A display program according to Note 83, wherein slave display objects are displayed in a predetermined positional relationship under a master display object on the basis of the subordinate information.

(Note 85)

A display program according to any one of Notes 67 through 84, wherein there is further executed a step of obtaining a correlation between the plurality of display objects by comparing these display objects.

(Note 86)

A display program according to any one of Notes 67 through 85, wherein there is further executed a step of obtaining a difference between the plurality of display objects by comparing these display objects.

(Note 87)

A display program according to any one of Notes 67 through 86, wherein there is further executed a step of generating ranking information by comparing the plurality of display objects.

(Note 88)

A display program according to any one of Notes 67 through 87, wherein input operations by a plurality of users operating a plurality of operation units are accepted.

(Note 89)

A display program according to Note 88, wherein the plurality of operation units are pointing devices.

(Note 90)

A display program according to any one of Notes 67 through 89, wherein there is further executed a step of transmitting the image data to other display device to get the image data displayed thereon.

(Note 91)

A display program according to any one of Notes 67 through 90, wherein there is further executed a step of transmitting the display object displayed on the display unit by copying or clipping the display object to other display device, and getting the display object displayed thereon.

(Note 92)

A display program according to any one of Notes 67 through 91, wherein there is further executed a step of transmitting, in the case of displaying the display object by transferring the display object within the display area on the display unit, the display object to other display device provided in parallel with the transferring direction thereof, and getting the display object displayed thereon.

(Note 93)

A display program according to any one of Notes 67 through 92, wherein the user identifying step involves identifying a movement of the user, and the personal campus associated with the user is transferred within the display area on the display unit as the user moves, and displaying is thus performed.

(Note 94)

A display program according to any one of Notes 67 through 92, further comprising a step of imaging the user,

wherein a motion of the user is recognized based on the captured image, and

the display object associated with the user is displayed in accordance with the motion of the user.

(Note 95)

A display program according to any one of Notes 67 through 94, further comprising a step of imaging the users,

wherein a distribution of the users is recognized based on the captured images, and

the display objects are displayed in accordance with the distribution of the users.

(Note 96)

A display program according to any one of Notes 67 through 95, further comprising a step of performing communications with a user terminal,

wherein the communication performing step involves transmitting the history information of the display objects displayed on the display unit to the user terminal.

(Note 97)

A display program according to any one of Notes 67 through 95, further comprising a step of performing communications with a user terminal,

wherein the step of performing the communications with the user terminal involves transmitting the history information of the display object manipulated by the user to the user terminal on the basis of the user information.

(Note 98)

A display program according to Note 97, wherein the step of performing the communications with the user terminal involves, when receiving the history information from the user terminal, getting the display object displayed based on the history information.

(Note 99)

A display program according to any one of Notes 67 through 98, wherein there is further executed a step of receiving the display object from a management device on a network.

(Note 100)

A display system constructed of a display device and a management device that are connected via a network,

the display device comprising:

an object acquisition module receiving a display object from the management device;

an operation unit accepting a user's operation about the display object;

a user identifying module identifying a user who performed the operation;

an attribute recording module recording a user attribute specifying the user identified by the user identifying module and the display object in a way that associates the user attribute with the display object;

an image processing module generating image data by executing a process corresponding to the user attribute associated with the display object; and

a display unit displaying the image data.

<Incorporation by Reference>

The disclosures of Japanese patent application No. JP2005-105004 filed on Mar. 31, 2005 including the specification, drawings and abstract are incorporated herein by reference.

1. A display device comprising:
an operation unit accepting a user's operation about a display object;
a user identifying module identifying a user who performed the operation;
an attribute recording module associating a user attribute specifying the user identified by the user identifying module with the display object;
an image processing module generating image data by executing a process corresponding to the user attribute associated with the display object; and
a display unit displaying the image data.

2. A display device according to claim 1, wherein when the operation unit accepts a user's operation of displaying the display object, the image processing module displays the display object in a user's personal campus set in at least part of a display area of the display unit.

3. A display device according to claim 1, wherein the image processing module rearranges a plurality of display objects in accordance with ranking information of the display objects.

4. A display device according to claim 1, wherein the user identifying module identifies a position of the user, and
the image processing module controls a display size of the display object associated with the user, corresponding to the position of the user.

5. A display device according to claim 1, wherein the attribute recording module assigns a group ID to a plurality of display objects that are to be grouped, and
the image processing module processes batchwise the plurality of display objects specified by the group ID.

6. A display device according to claim 1, wherein the plurality of display objects have subordinate information representing a mutual subordinate relationship, and
the image processing module gets the plurality of display objects displayed based on the subordinate information.

7. A display device according to claim 1, further comprising an object analyzing module obtaining a correlation between the plurality of display objects by comparing these display objects.

8. A display device according to claim 1, further comprising an object analyzing module obtaining a difference between the plurality of display objects by comparing these display objects.

9. A display device according to claim 1, further comprising an object analyzing module generating ranking information by comparing the plurality of display objects.

10. A display device according to claim 1, further comprising a display linkage module transmitting the image data to other display device to get the image data displayed thereon.

11. A display device according to claim 1, further comprising a display linkage module transmitting the display object displayed on the display unit by copying or clipping the display object to other display device, and getting the display object displayed thereon.

12. A display device according to claim 1, further comprising a display linkage module transmitting, in the case of displaying the display object by transferring the display object within the display area on the display unit, the display object to other display device provided in parallel with the transferring direction thereof, and getting the display object displayed thereon.

13. A display device according to claim 1, wherein the user identifying module identifies a movement of the user, and
the image processing module transfers the personal campus associated with the user within the display area on the display unit as the user moves, and thus performs displaying.

14. A display device according to claim 1, further comprising an imaging unit imaging the user,
wherein the user identifying module recognizes a motion of the user on the basis of the image captured by the imaging unit, and
the image processing module displays the display object associated with the user in accordance with the motion of the user.

15. A display device according to claim 1, further comprising an imaging unit imaging the users,
wherein the user identifying module recognizes a distribution of the users on the basis of the images captured by the imaging unit, and
the image processing module displays the display objects in accordance with the distribution of the users.

16. A display device according to claim 1, further comprising a user linkage module performing communications with a user terminal,
wherein the user linkage module transmits the history information of the display objects displayed on the display unit to the user terminal.

17. A display method by which a display device executes steps of:
accepting a user's operation about a display object;
identifying a user who performed the operation;
associating a user attribute specifying the identified user with the display object;
generating image data by executing a process corresponding to the user attribute associated with the display object; and
causing a display unit to display the image data.

18. A display method according to claim 17, wherein there is further executed a step of transmitting the image data to other display device to get the image data displayed thereon.

19. A display method according to claim 17, wherein the user identifying step involves identifying a movement of the user, and
the personal campus associated with the user is transferred within the display area on the display unit as the user moves, and displaying is thus performed.

20. A recording medium recorded with a display program for making a computer execute steps of:
accepting a user's operation about a display object;
identifying a user who performed the operation;
associating a user attribute specifying the identified user with the display object;
generating image data by executing a process corresponding to the user attribute associated with the display object; and
causing a display unit to display the image data.
